(19) United States
(12) Patent Application Publication
(10) Pub. No.: US 2019/0331917 A1
(43) Pub. Date: Oct. 31, 2019

(54) PERSONAL 3D AND 2D VIEWING DEVICE

(71) Applicant: Stuart Brooke Richardson, Vancouver, WA (US)

(72) Inventor: Stuart Brooke Richardson, Vancouver, WA (US)

(21) Appl. No.: 15/961,894

(22) Filed: Apr. 25, 2018

(51) Int. Cl. G02B 27/01; G02B 27/02; G02B 27/22; G03B 35/18

(52) U.S. Cl. CPC G02B 27/0172; G03B 35/18; G02B 27/2235; G02B 27/02

(57) ABSTRACT

A personal, portable Virtual Reality system comprising a headset, i.e., a head-worn device, which itself contains two separate 16:9, landscape-oriented optical systems, one for each of the user's eyes, and two 16:9 display screens, the combination of which creates an optical illusion within the viewing field of the user, which illusion tricks the user's brain into thinking that the user is seeing a singular 16:9, landscape-oriented 3D and/or 2D screen, which singular virtual screen the user perceives as being magnified in size, and extended many feet into the distance, rather than the two separate display screens inside said headset, which are in reality small and at very close range. Said VR system may also comprise a shoulder-array which offloads the weight of the processing and battery hardware from the headset, various means of protecting the user from direct WIFI signals emanating from the apparatus, and various versions of the headset offering different options for fixed and/or one or two user-installed smartphones, which smartphones would be used as the display screen(s) and processing/battery hardware of said system. Said system may also comprise a pair of video cameras, to capture stereo-optic environmental imagery for superimposing onto the existing imagery within the device, and integrated audio headphones.

### CROSS REFERENCE TO RELATED APPLICATIONS

This Non-provisional Patent Application includes extended temporal protection under 35 U.S.C. § 119(e) via Provisional Patent Application No. 62/489,428, filed in the U.S. on Apr. 24, 2017 by the same sole inventor, Stuart Brooke Richardson.

### BACKGROUND OF THE INVENTION

### Field of Invention

This invention relates to the field of personal, head-worn 3D (3 Dimensional) and 2D (2 Dimensional) viewing devices.

### Related Art

Because the eyes of humans are spread a few inches apart, each eye experiences a unique perspective that is slightly shifted from the other—this is a principal widely known as ‘parallax’. Our brains combine the two 2-dimensional images that our eyes receive into a singular virtual 3D ‘image’—this is how humans perceive depth in the natural world.

Virtual parallax, on the other hand, mimics optical parallax by presenting the user with synthesized image pairs, one image for the right eye and one for the left eye. Such 3D images are created in various ways using various methods, but the result is always the same, with two images that are ‘seen’ from slightly different perspectives.

For instance, two optical cameras placed a few inches apart will ‘act’ as the eyes of the user and, since the eyes of humans are a few inches apart, any image pair taken using a pair of such cameras arranged in this way, using the same camera settings would, together as a pair, exhibit the features of virtual parallax. Then, with said images placed in front of the user's eyes, one before each eye, the user's brain would combine the two separate images together, creating within the user's mind a virtual 3D ‘scene’ which is represented by the image pair. This is the foundation of the 3D imaging paradigm.

In the case of 3D video (including gameplay) the general methodology is the same, but the image pairs are shown sequentially very rapidly, creating in the mind of the user a synthetic 3D ‘scene’ which manifests as fluid motion.

As a side note, 2D viewing of images and/or video is accomplished easily with 3D viewers, simply by duplicating a single 2D image or video so that each of the user's eyes sees the same image and/or video.

The most common 3D viewing method that manufactures have historically been using is what is known as the ‘side-by-side’ method. This method places two display screens side by side—or a single wide screen slit down the middle, placing a virtually-parallaxed image pair directly in front of the user's eyes, one image in front of each eye. The side-by-side method is a flawed paradigm as it imposes three severe limitations; the first being image resolution due to the ‘pixel density’ problem; the second being the size limitation of useable screens owing to the fact that the distance between the eyes of humans is small; and the third being widescreen viewing, which is directly related to the previous two problems. Devices using the side-by-side method do not offer native widescreen viewing because doing so would severely limit the total size of their display screens, since it is the width of side-by-side screens that is the limitation, and since those manufacturers who produce such devices want to take advantage of the fact that screen height is not limited within that paradigm.

With an average distance of around 2.3 inches between the eyes of most humans, it means that screens no wider than around 2.3 inches would function with the side-by-side method, since screens any wider than this would hit and block each other. This also means that pixel density within the side-by-side paradigm is fixed to an upper limit due to the small screen sizes, meaning that a true HD (High Definition) quality of UHD (Ultra High Definition, or 2160p) is well out of reach for such side-by-side devices, at least for a number of years, until display screen technology can catch up to the needs of such VR device manufacturers, by offering pixel densities far in excess of the current maximum which—as of this writing—is at around 800 PPI (Pixels Per Inch). Because of these stated problems, devices based on the side-by-side method are very poor choices for the viewing of modern TV shows, cinematic movies, high-end video games, high-resolution computer desktops, eSports streams, or any digital content that requires a combination of high resolution and native widescreen formatting.

### SUMMARY OF THE INVENTION

The current invention is a 3D/2D viewing device that is worn on the face and head of the user, and because of its very high resolution and native 16:9 widescreen formatting will be ideally suited for the viewing of high-definition TV shows, cinematic movies, as well as viewing any other digital content that would benefit from these unprecedented device features. The current invention solves all three of the aforementioned problems with the side-by-side display method, and does so all at once through the use of optics. The proposed system mounts on the user's face and head in such a way that the user's eyes gaze comfortably and directly into the device. A system of adjustable and flexible head-straps is provided to secure the apparatus to the user's head in a comfortable and convenient fashion, and multiple versions and configurations of the complete apparatus are outlined within this text.

Said headset enables both 3D and 2D viewing of digital content, which includes still images, video, gameplay, GUI (Graphical User Interface) components, internet content, etc., via the use of two separate internal display screens.

The three disclosed problems associated with the side-by-side methodology are here solved by placing an optical system in front of each eye, which allows the display screens to be physically displaced, hence spatially separated, thereby bypassing the problem of the limited spacing between the user's two eyes.

This new spatial separation technique allows larger display screen sizes to be used, and also wider display screens—i.e. display screens that are widescreen formatted. The use of larger display screens puts to an immediate end the aforementioned problem of resolution, since 5.5-inch diagonally measured display screens are now being manufactured in the industry with UHD resolution. The new spatial separation technique of the current invention also puts an end to the aforementioned widescreen limitations of the side-by-side paradigm, allowing for the first time true native widescreen viewing in a head-worn 3D/2D device. It is this combination of high resolution and native widescreen, via this optical separation technique, which makes the detailed invention so innovative and unprecedented.

The two optical systems within the described apparatus are bisymmetrically arranged, as front-surface mirror-opposites of each other. Each optical system is composed of a converging lens and a front-surface mirror. It is the front surface mirrors in the device which allow the flexible placement of the display screens within the apparatus, and in this case the front-surface mirrors deflect the user's gaze both upward and outward, thus allowing the display screens to be placed well apart from one another. This wide spacing is what allows the display screens to be much larger than those used in the side-by-side methodology. Thus the first problem of the side-by-side method is solved here—that of the allowance of larger display screen sizes.

The allowance of larger display screens itself solves the second problem of the side-by-side method, that of pixel density. Because modern smartphones are already being manufactured in the industry with UHD display screens of 5.5 inches diagonal—which corresponds to a pixel density of 806 PPI—it means that the device specified in the current invention can use such display screens and thus feature UHD resolution per eye, which would be an industry first. It also means that the third problem in the side-by-side paradigm—the ‘widescreen problem’—can be solved at the same time, since such modern smartphone display screens use the global standard widescreen format of 16:9 ratio, landscape oriented.

Because the front-surface mirrors are arranged at a sharp compound angle, the front-surface mirrors must be cut to a special shape which, from the viewing angle of the user's eyes, appear to the user as rectangles of 16:9 landscape-oriented ratio, to conform with the 16:9 widescreen format of the display screens.

And it is no matter that front-surface mirrors arranged in such a fashion throw off the rotational orientation of whatever they're reflecting in a rather extreme manner. In the layout of this device, the display screens are simply rotated to compensate, so that the user sees a correctly aligned image for each eye, which allows the user's brain to combine the two perfectly aligned images together to produce a singular virtual 3D ‘scene’.

The converging lenses in the system re-focus the user's eyes in such a way that the display screens can be clearly seen at such close distance.

It is this very special combination of elements—the front-surface mirrors which facilitate the physical separation of the two display screens, the odd shape and extreme compound angle of those front-surface mirrors which creates an intended optical illusion, the rotational displacement that their extreme angles create, the rotational compensation realized in the final placement of the display screens, and the widescreen ‘shaping’ of all optical elements—converging lenses and front-surface mirrors, as well as the display screens—which together allow such a vast improvement in digital content viewing for a head-mounted device.

### BRIEF DESCRIPTION OF THE DRAWINGS

The accompanying drawings are for clarification purposes only, and should therefore not limit the interpretation of the textual specifications but only augment the specifications.

FIG. 1 shows the headset in its totality, from a front/side perspective.

FIG. 2 shows the headset in its totality, from a rear-side perspective.

FIG. 3 shows the right eye assembly of the headset, rear/side perspective view.

FIG. 4 shows the left eye assembly of the headset, rear/side perspective view.

FIG. 5 shows the optical system within the headset, rear/side perspective view.

FIG. 6A, FIG. 6B and FIG. 6C show the right-side front-surface mirror within the headset, the virtual 16:9 rectangle created by the angle of the devices' front-surface mirrors, and the four angles which create the particular shape of said front-surface mirrors.

FIG. 7 shows a right side orthogonal view of the optical system within the headset, in relation to its display screen.

FIG. 8 shows a top orthogonal view of the optical system within the headset, in relation to the display screens.

FIG. 9 shows the left front-surface mirror mount and the three left converging lens mounts within the headset.

FIG. 10 shows an exploded view of the smartphone mount, which can be installed on the right and/or left side of the apparatus, depending on the desired configuration, and shown here with a smartphone installed.

FIG. 11 shows an exploded view of the fixed display screen assembly, which can be installed on the right and/or left side of the apparatus, depending on the desired configuration.

FIG. 12A shows the six tube and sleeve components of the headset in a front orthogonal view, which components hold the left and right enclosures together, and which also allow the optical width of the entire unit to be adjusted via sliding action.

FIG. 12B shows the six tube and sleeve components of the headset in a top orthogonal view, which hold the left and right enclosures together, and which also allow the optical width of the entire unit to be adjusted via sliding action.

FIG. 13 shows an alternative arrangement within the headset, for processing and battery hardware.

FIG. 14 and FIG. 15 show two different perspectives of another alternative arrangement for processing and battery hardware, worn on the shoulders of the user in a strap-on configuration.

FIG. 16 shows a top view of an alternative arrangement for a WIFI antenna, built into the headset.

FIG. 17 and FIG. 18 show two different perspectives of another alternative arrangement for WIFI, via a WIFI antenna built into the top head-strap of the headset.

FIG. 19 shows a front orthogonal view of an alternative arrangement for one or two WIFI antennas, built into the shoulder-pack(s) of one of the alternative versions of the system.

FIG. 20A and FIG. 20B show optional video cameras installed in the headset, from both and perspective views.

FIG. 21 shows an alternative configuration which provides integrated headphones.

### DETAILED DESCRIPTION OF THE INVENTION

The following text describes in detail the functionality of the invention, along with descriptions of the various assemblies and parts, with reference to the associated drawings which are included for clarification of said text.

This text assumes an XYZ Cartesian coordinate system based in the normal three dimensions of space, within which the Y axis is along the forward line of sight of the user who is wearing the apparatus in question, in other words front and back of the user; the X axis runs left and right of the user; and the Z axis runs up and down from the user's perspective.

This invention is a VR (Virtual Reality) system which features a head-mounted apparatus that the user dons on his/her face using the included strap-based system, so that the user's eyes are optically interfaced with the apparatus. The strap-based system is user-adjustable, to accommodate different head sizes, and made of flexible material to provide constant tension for the sake of keeping the head-mounted apparatus—i.e. the headset—comfortably mounted to the user's face and head.

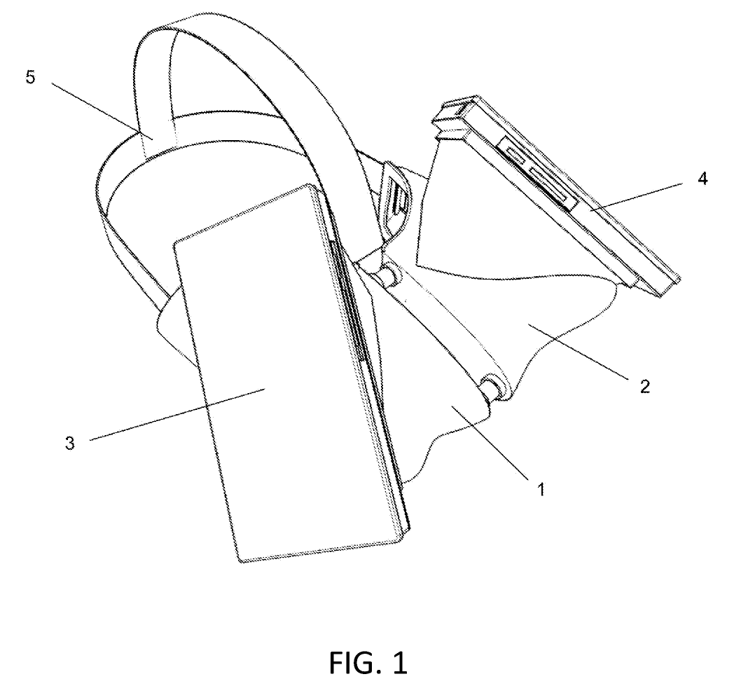

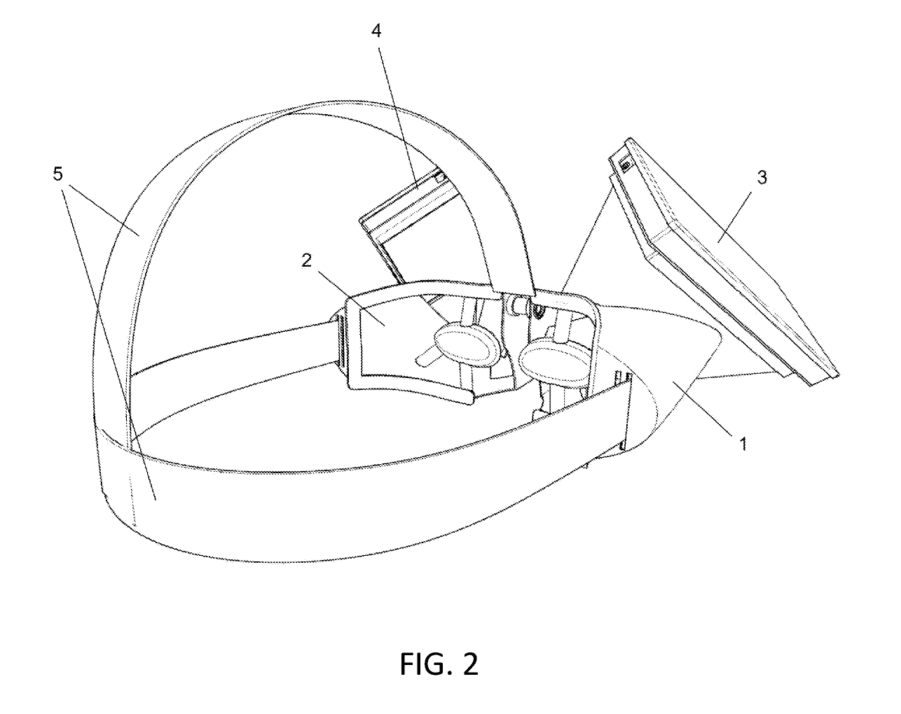

FIG. 1 is a broad view of the headset in its entirety, from a front perspective view, and FIG. 2 shows the entire device from a rear perspective view. It can be seen from these views that the device consists of two major assemblies, right eye assembly 1 and left eye assembly 2. These assemblies contain the optical components of the system. These two assemblies are bisymmetrically composed and arranged, and each optical assembly contains one converging lens and one front-surface mirror, the finer details of which will be fully disclosed below.

Right eye assembly 1 and left eye assembly 2 are mounted together to form a singular stereoscopic system, allowing the user to be exposed to 3D or 2D digital content supplied by the two 16:9 display screens, one display screen contained within screen assembly 3 and the other display screen contained within screen assembly 4, in such a way that the user believes that he/she is seeing a singular virtual 16:9, landscape-oriented image.

Before going into great detail about the apparatus, let it be known first that there are multiple versions of said complete apparatus disclosed here, some with different screen configurations. That being said, the functional principles are identical for all said versions of the device, regardless of screen configuration, because in all the configurations the screens—regardless of which type or size—are always in the same position. For most of the foregoing text it will be assumed that the version that is being presented is the version which contains one fixed display screen on the right side of the apparatus, screen assembly 3, and one moveable screen on the left side of the apparatus, screen assembly 4, which screen is provided by the user in the form of his/her smartphone, which the user installs temporarily into the device.

The device as a whole presents the user's right eye with the digital content that is emanating via right eye assembly 1 from the display screen in screen assembly 3, and presents the user's left eye with the digital content that is emanating via left eye assembly 2 via the display screen in screen assembly 4.

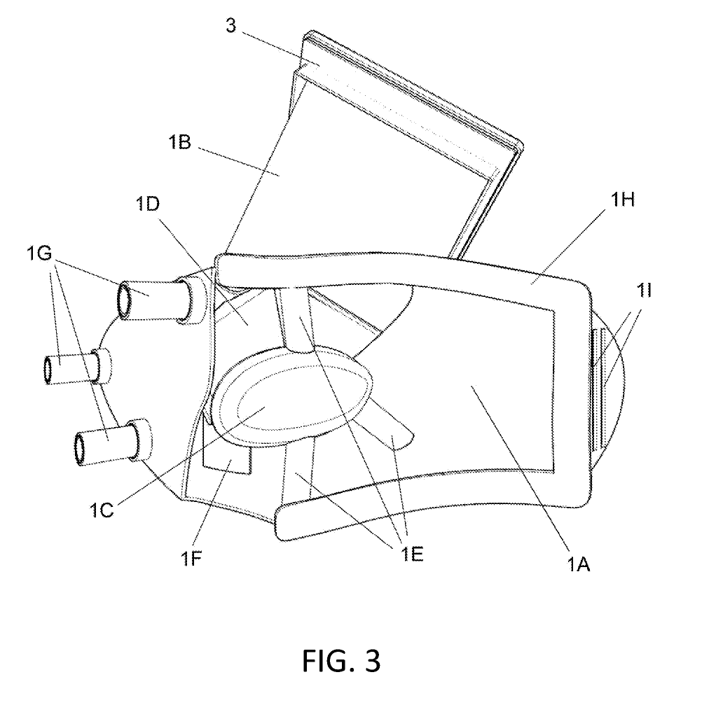

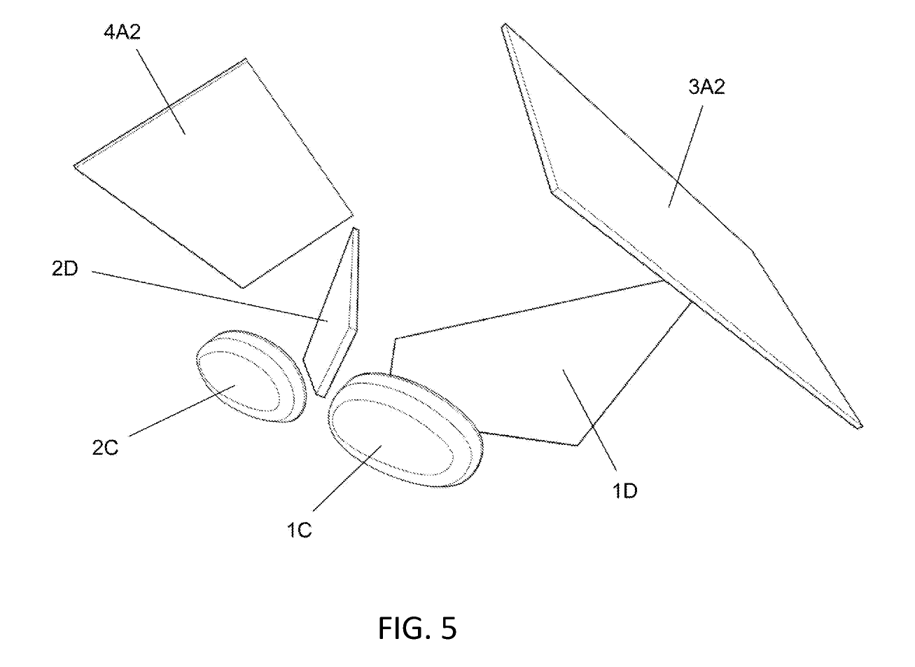

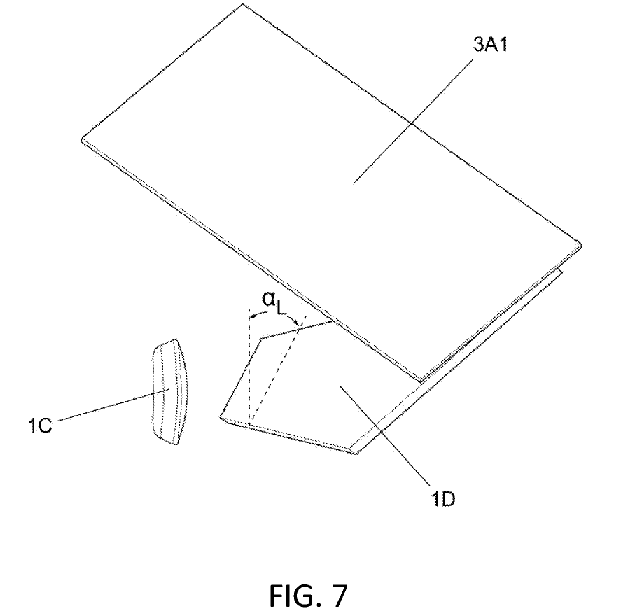

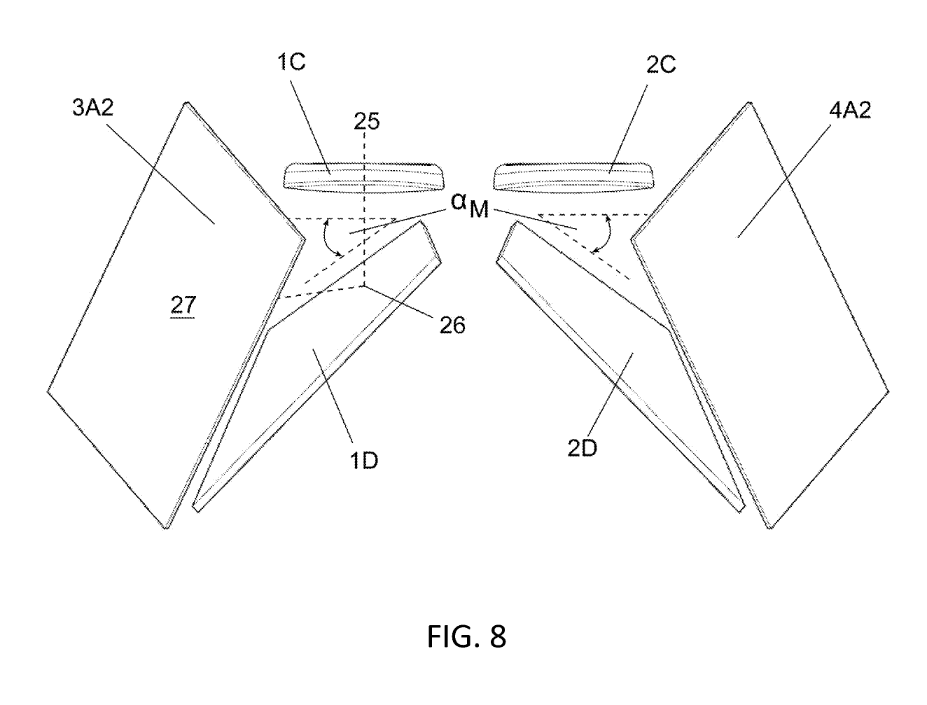

FIG. 3 shows the right side assembly 1 along with right side screen assembly 3, and FIG. 5 shows a perspective view of the optical components of the entire system, as well as the display screens, without the other parts obstructing the view of the optical layout. FIG. 7 shows the right side optics and display screen, from a right orthogonal view, and FIG. 8 shows the optical system and display screens from a top orthogonal view.

It should be borne in mind throughout the reading of this text that this right side assembly is identical in every way to the left side assembly 2, with the exception that it is bisymmetrically arranged, so that any discussion of either side applies equally to the opposite side, although in the bisymmetrical sense.

Right side assembly 1 rests gently against the user's face via the soft padding provided by foam interface 1h. This arrangement places the user's eye within very short range of converging lens 1C, which is a converging lens of +7.5 diopter strength, manufactured at a 16:9 ratio for widescreen viewing, with a width of 2 inches and a height of 1.2 inches, and which sits approximately 0.5 inches away from the cornea of the user's right eye along the Y axis. This converging lens acts as a re-focusing element, allowing the user's eye to comfortably focus on display screen 3A2, which is at a compound distance of 4.42 inches. This compound distance includes the distance between converging lens 1c and front-surface mirror 1D, and between front-surface mirror 1d and display screen 3A, both distances being added together.

Be it known that the distance between converging lens 1c and front-surface mirror 1D is not critical, nor is the distance between front-surface mirror 1D and display screen 3A, as a change in distance can be compensated by a change in diopter power of converging lens 1C. Far more critical, however, are the angular alignments between these three components, since the functionality of the apparatus as a whole fully depends on the eyes of the user seeing two 16:9 landscape-oriented images, one image for each eye, which said images have then converged—in the user's mind—into one single virtual image. This can only be accomplished when the angular alignment of all components is accurate.

Be it also known that decreasing the distance between said three components would accomplish the enlargement of the virtual image, and increasing said distance would accomplish a diminution of said virtual image, whichever is the goal of the manufacturer.

A fine balance has been struck with the current design, as stated herein, and as shown in the illustrations, with a distance of 1.13 inches from the center of the convex surface of converging lens 1C to the ‘center point’ of front-surface mirror 1D, said ‘center point’ of front-surface mirror 1D being the point through which the user's gaze would penetrate if the user was gazing straight forward along the Y axis.

And in the case that the user is gazing straight forward along the Y axis, that same gaze would strike a point on front-surface mirror 1D—which shall henceforth be called the ‘center point’ of said front-surface mirror within this text—and be deflected off of that same point on said front-surface mirror and land on the very center of display screen 3A2, which is at a distance of 3.29 inches from the ‘center point’ on front-surface mirror 1D to said center point on display screen 3A2. This renders a compound distance between converging lens 1D and display screen 3A2 of 4.42 inches, as measured using the aforementioned ‘center points’ on each of those three components—converging lens 1C, front-surface mirror 1d and display screen 3A2.

Said distances are also dependent on the precise angular positioning of said three components, in respect to each other and also in respect to the user.

As shown in FIG. 8, converging lens 1c should be permanently positioned to be approximately tangent to the user's right eye, so that the converging lens is perpendicular to the user's forward gaze, and at a distance of approximately 0.5 inches from said eye (25). Assuming the user's right eye is well aligned with the center of converging lens 1C, and assuming the user's gaze is straight forward along the Y axis, said gaze should strike a point on front-surface mirror 1D (26), which shall from this point onward in this text be known as the ‘center point’ of said front-surface mirror. Having struck this ‘center point’ on said front-surface mirror, the user's gaze is then deflected partly to the right of the user and partly upward, at a critical compound angle.

The exact compound angle of front-surface mirror 1D—if said front-surface mirror started out sitting exactly perpendicular to the user's forward gaze along the Y axis, as if the user was looking at his or herself in said front-surface mirror, and said gaze was striking center point 26 on said front-surface mirror—is 28.7 degrees clockwise rotation (FIG. 7, angle αL) as viewed from the right orthogonal view, so that the viewer's gaze is deflected upward yet still backward. Then, as seen from the top orthogonal view (FIG. 8), front-surface mirror 1D is rotated 40.973 degrees counterclockwise (angle αM), so the user's gaze is deflected toward the user's right side.

The last step in finding the optimum fixed position of front-surface mirror 1D—as seen from a head-on view of the front-surface mirror, as if looking directly into it—is to rotate said front-surface mirror 5.6 degrees clockwise, using center point 26 as the pivot point, and without deviating from the plane made by said front-surface mirror's surface.

Now that the deflected angle of the user's gaze via front-surface mirror 1D is properly ascertained, let it be known that display screen 3A2 should then be placed exactly perpendicular to the fully deflected gaze of the user, if said gaze was seen as a virtual line extending forward along the Y axis from the user's cornea (FIG. 8, point 25), through the middle of converging lens 1C, striking the ‘center point’ of front-surface mirror 1D (point 26), and deflecting off said center point at the composite angle described in this text, and striking display screen 3A2 at its own center point (point 27). Having positioned display screen 3a2 thusly, said display screen should then be rotated—without changing the position of its center point or its perpendicular angle in respect to the user's forward gaze—so that the image on said display screen, from the perspective of the user's right eye, having been deflected by front-surface mirror 1D, appears to the user as a perfect 16:9 landscape orientation.

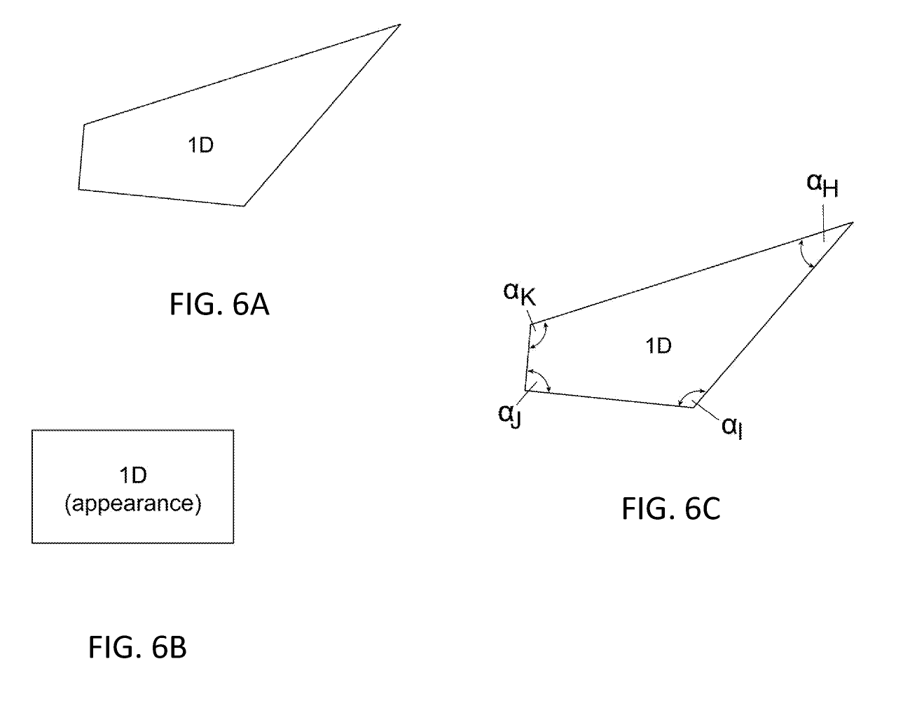

The two front-surface mirrors in this device, front-surface mirror 1D and front-surface mirror 2D, are of a distinct shape and size, as shown in FIG. 6A, a fact which greatly reduces the size of the apparatus as a whole by minimizing the overall size of said front-surface mirrors, thus allowing the size of lower enclosures 1A and 2A to be minimized. These front-surface mirrors, as shown in FIG. 6C, should be constructed with the longest dimension, i.e. the length between the two farthest corners, being 5 inches, and with the following corner angles: αH=34 degrees, αI=125 degrees, αJ=91 degrees, and αK=110 degrees. The two front-surface mirrors are bisymmetrically cut, and with the front-surfaces positioned closest to the user.

FIG. 6A shows front-surface mirror 1D, with its real shape, as seen if said front-surface mirror was viewed head-on. Since the front-surface mirror is not normally viewed head-on by the user, said front-surface mirror being permanently positioned at the compound angle previously disclosed, said front-surface mirror appears to the user with the virtual shape of a 16:9 landscape-oriented rectangle, as shown in FIG. 6B, which allows the 16:9 landscape-oriented display screen 3A2 to reflect said display screen in an ideal manner, so that the user's right eye simply sees a 16:9 landscape-oriented image, with very little extra trim being visible around the ‘virtual’ impression of the front-surface mirror.

The exact same thing can be said about front-surface mirror 2D, only that it is bisymmetrically designed and arranged, but with the same affect being a ‘virtual’ mirror with the same 16:9 landscape-oriented appearance, from the user's perspective.

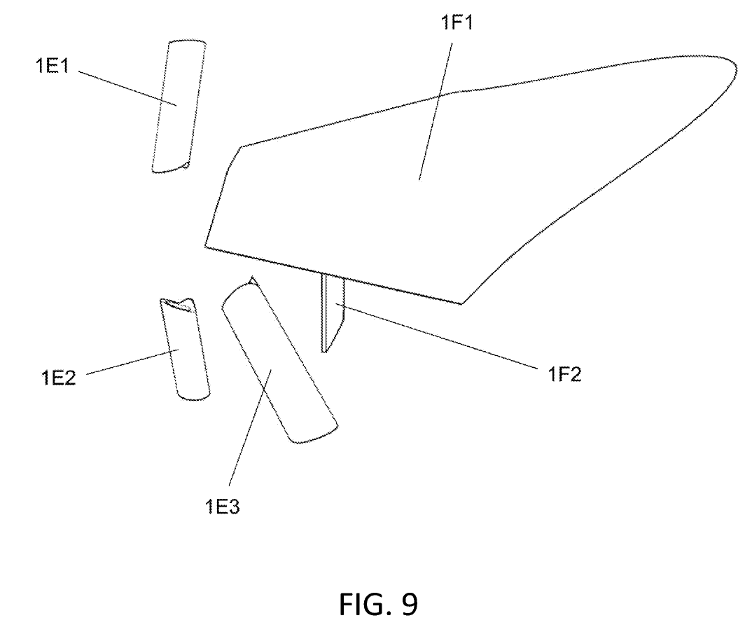

FIG. 9 shows the mounting hardware for front-surface mirror 1D and for converging lens 1C. Hardware 1F1 and 1F2 are manufactured in such a way that the compound angle of front-surface mirror 1C is not affected in any way, and lens mounts 1E1, 1E2 and 1E3 are manufactured in such a way that the position of converging lens 1C, according to the previous text, is not affected in any way. These features are most easily accomplished by manufacturing the mounting hardware of the right-eye side together with the enclosures of the right-eye side, into one singular structure, using standard 3D printing and injection molding techniques. Then the optical components are glued in place and tested for proper alignment.

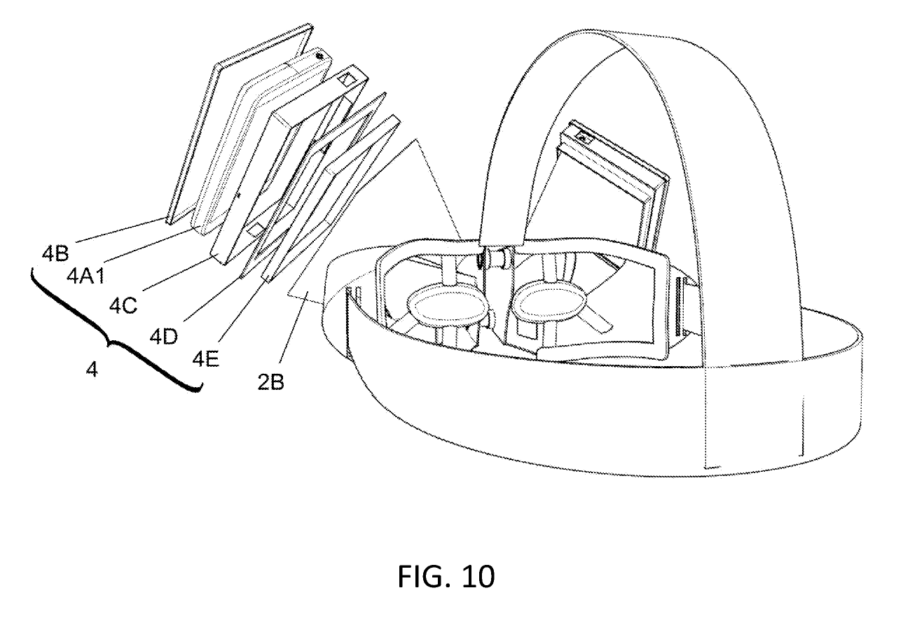

FIG. 10 shows left-side phone-mount assembly 4 which shall be manufactured in such a way that a modern smartphone can be inserted into the mount by the user, and closed so that the phone does not move or fall out. This can be accomplished either by manufacturing different phone mounts, one for each size and shape of smartphone on the market, or by manufacturing a flexible mount which can accept a range of smartphone sizes and shapes. The mount shown in FIG. 10 shows the former of those two arrangements.

This assembly comprises flange 4E which fits snugly around the lip of enclosure 2B, and on top of flange 4E is screen rest 4D, upon which the display screen of the phone rests and is masked by the shape of screen rest 4D. Enclosure 4C surrounds the phone, and also provides holes for accessing phone buttons and electronic jacks. 4A1 is the smartphone itself, which would be supplied by the user, and since most people already have a smartphone this option makes this version of the headset far more economical for the user. Lid 4B covers the smartphone mount so the phone doesn't fall out of the mount. Phone mount assembly 4 can also be used on the right-eye side of the device without any modification, if two smartphones are desired.

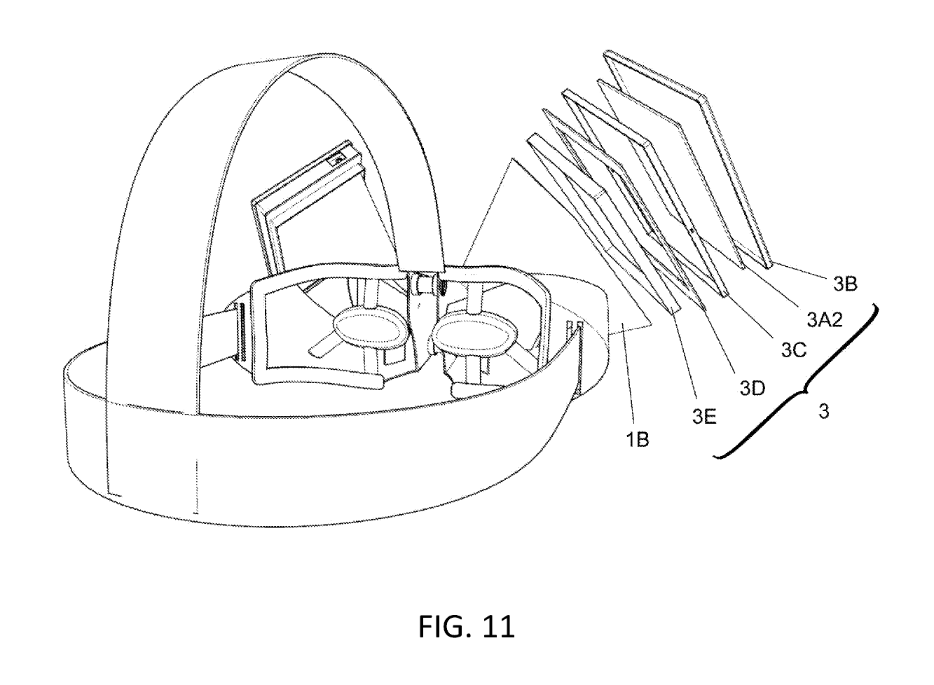

FIG. 11 shows right-side fixed display screen assembly 3, which need not be opened by the user, and which can be manufactured in different sizes according to which display screen size the manufacturer desires for that particular model, and/or which display screen size the user has inserted in the form of his/her smartphone. For instance, assembly 3 can be manufactured with a 5-inch display screen for those users who have smartphones with 5-inch display screens, and can also be manufactured with a 5.5-inch display screen for those users who have a smartphones with 5.5-inch display screens, and so on for any size screen. Fixed display screen assembly 3 comprises flange 3e which fits snugly around the lip of enclosure 1B, and on top of flange 3E is screen rest 3D, upon which the fixed display screen rests and is masked by the shape of screen rest 3D. Enclosure 3C surrounds the display screen. 3A1 is the fixed display screen itself, and lid 3B covers the fixed display screen to protect it from dust, water, etc.

An alternative arrangement would be to manufacture a single version of assembly 3, with a fixed display screen that is 6 inches in diameter (3A1), and with software which allows the image on the display screen to be adjusted by the user in size, position, brightness/contrast, etc., so that the user can insert a smartphone of any size that has a display screen 6 inches diagonal or smaller, and be able to ‘tailor’ the properties of the image on the right display screen to match those of the image on the left.

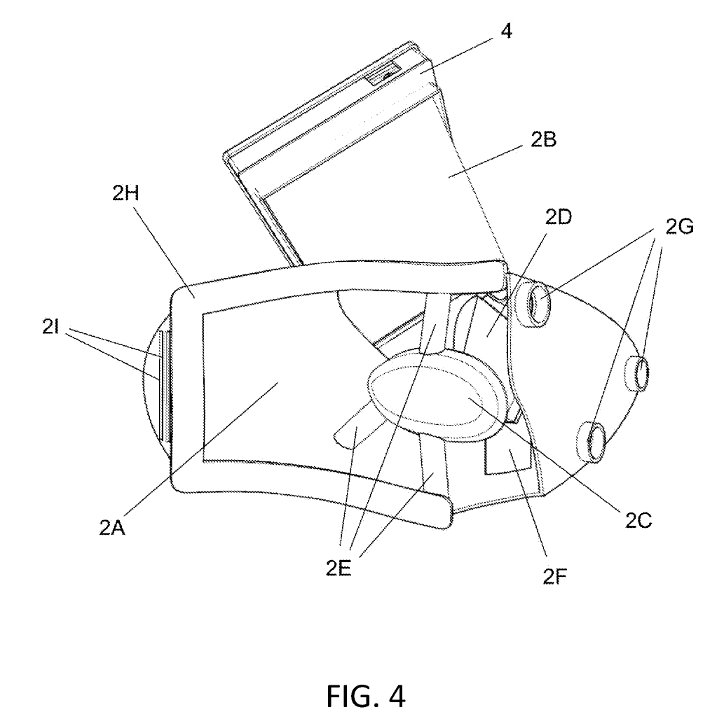

FIG. 3 and FIG. 4 show the system that mounts the left-eye and right-eye assemblies together. This mounting system offers the flexibility of allowing the user to adjust the distance between the left-eye side and the right-eye side, since humans have different head sizes and also different spacing between their eyes, sometimes referred to as the inter-optical distance. This spacing variability is accomplished by manufacturing members 1G and members 2G in such a way that members 1G can be inserted into members 2G, allowing members 1G to slide inside members 2G, although not too freely. The user then uses his/her hands to push the left-eye and right-eye assemblies together for a decreased head-size and/or inter-optical distance, or pulled apart for an increased head-size and/or inter-optical distance. This system allows the forward gaze of each user to always strike, as close as possible, the center of the display screens, which spacing adjustment allows the user to maintain control over the ‘global virtual depth’ of the perceived virtual environment, so that all users—whether big or small—will always be able to experience the same virtual depth in the digital content.

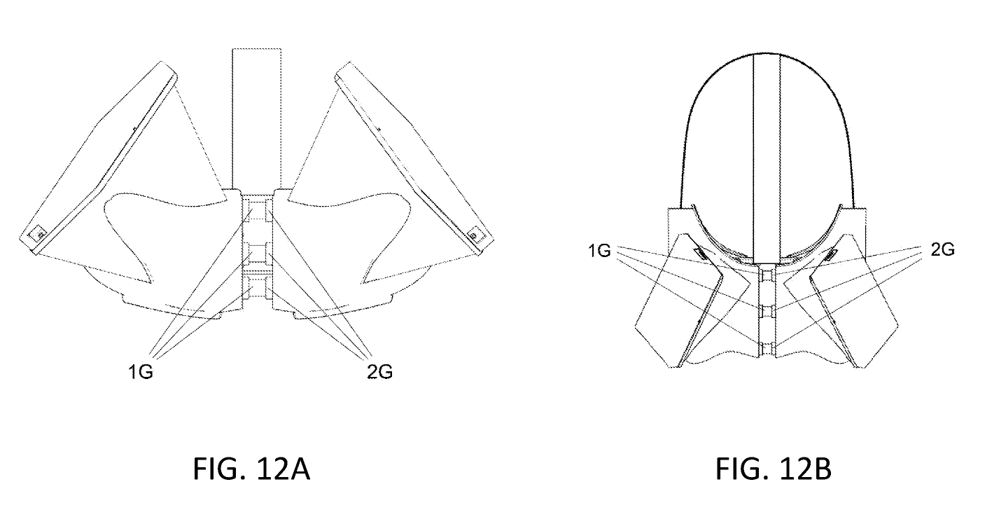

FIG. 12A shows a front orthogonal view of said members assembled together to represent a large inter-optical distance. FIG. 12B shows a top orthogonal view of the same configuration. FIG. 1 and FIG. 2 show two different perspective views of the same configuration, with the apparatus in its complete form.

Let it here be known that the device described in this document can be manufactured with multiple display screen configurations:

The first headset version would feature two display screens that are fixed and unmovable—as shown in FIG. 11 as screen 3A2, which assembly and screen would be bisymmetrically duplicated for the left eye side. This configuration would provide the user with the greatest ease of use and consequentially the greatest convenience. This version could be manufactured with two different sub-versions, one containing the normal CPU, memory, graphics processing hardware, networking hardware, electronic plugs and rechargeable battery associated with modern portable devices such as android and iOS smartphones, and the other devoid of these additional components, so that video-game enthusiasts can use their own outboard computers and processors for a more customized user experience.

The second headset version would feature a fixed display screen on the right side, which is unmovable, along with a CPU, memory, graphics processing hardware, networking hardware, electronic plugs and rechargeable battery for that side. The left eye side would feature the phone mount assembly shown in FIG. 10, which would allow the user to insert his/her own high-end smartphone—here designated as 4A1. This configuration would reduce the user's cost significantly due to the fact that most people in this modern time already own a high-end smartphone.

The third headset version would feature two phone-mount assemblies, similar to assembly 4A1 as shown in FIG. 10, although bisymmetrically manufactured, and pre-installed on the device in such a way that the user simply open the top of each phone mount assembly—shown in FIG. 10 as 4B, and insert a smartphone into each assembly, then connect them together via electronic cabling (such as USB). This version could decrease the user's cost even more, as it would allow the use of two smartphones that the user might already own, or could obtain at a relatively low cost.

The different display screen configurations will, because of the different types of display screens used in each version, will have different locations of hardware associated with computer processing, batteries, etc.

For instance, in the version featuring two user-supplied smartphones, all processing hardware, memory, networking components, batteries, etc. would be built into those smartphones, so no such hardware would be needed. The phones would simply be connected together via Micro-USB cable, as allowed via the access holes provided in FIG. 10, element 4C, which would in this case be an identical feature on the right-eye side.

The versions of the apparatus that feature one or more fixed display screens could also feature the same hardware arrangement, with processor, memory, networking components and battery attached directly to the associated display screen, just as a smartphone is manufactured.

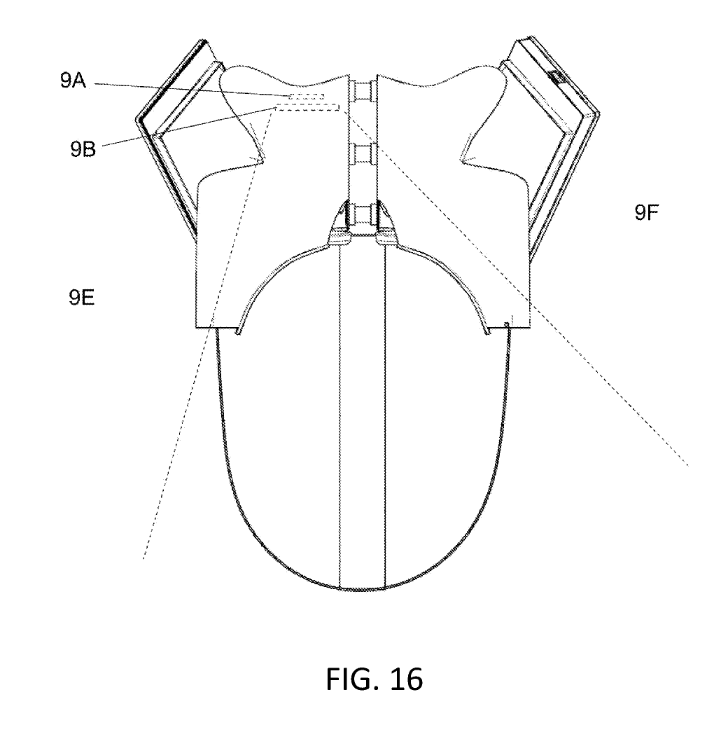

A specially designed WIFI antenna module could be placed in the front of one of the enclosures, as seen in FIG. 16, which WIFI module would include antenna 9a, as well as lead plate 9B, which would be covered with a non-toxic material such as plastic, said plate being shaped in such a way that it would shield the user's head and body from the direct radiation emanating from the WIFI antenna, but allowing WIFI radiation to emit forward and sideways, and only slightly backward, indicated by WIFI radiation zones 9E and 9F.

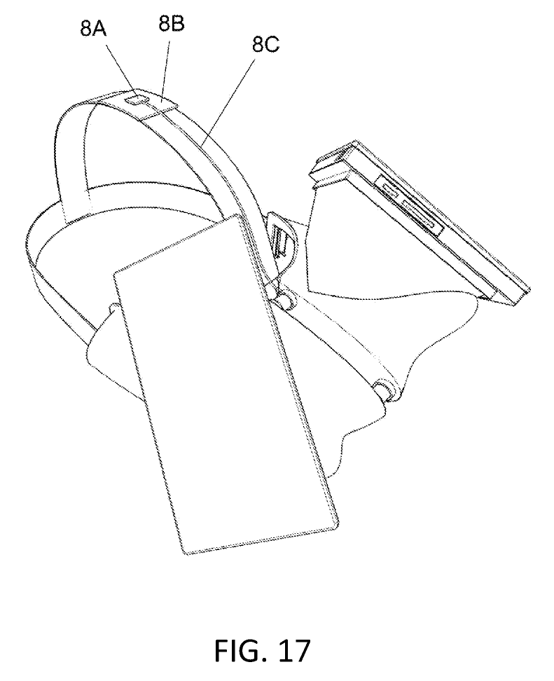

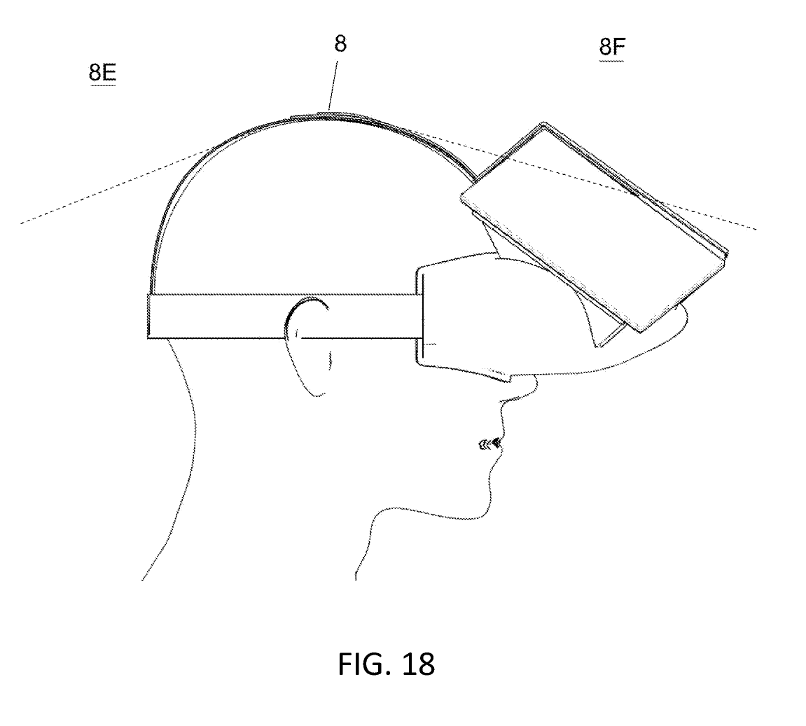

One alternative to this WIFI setup is shown in FIG. 17, which places WIFI antenna module 8 on top of the upper head-strap. This arrangement comprises WIFI antenna 8a, which sits atop lead plate 8b, which plate is surrounded by a non-toxic material such as plastic, and antenna cable 8C, which leads to the processing hardware. Said arrangement allows WIFI module 8 to radiate outwards in all directions except downward, allowing lead plate 8B to shield the user from the direct WIFI radiation of said antenna.

Any head-worn device should ideally be designed in such a way as to reduce the physical strain on the neck and face of the user as much as possible. One way of accomplishing this is to move the center of gravity as far ‘back’ as possible—from the user's perspective—by moving said extra hardware away from the display screens and more toward the face/head of the user.

And since it is also beneficial to have the weight of the apparatus balanced left and right—along the X plane, with the center of gravity being close to the middle of the user's face—it would be best to have some hardware on the left side of the device, and some hardware on the right side of the device, both locations as close to the user's face as possible.

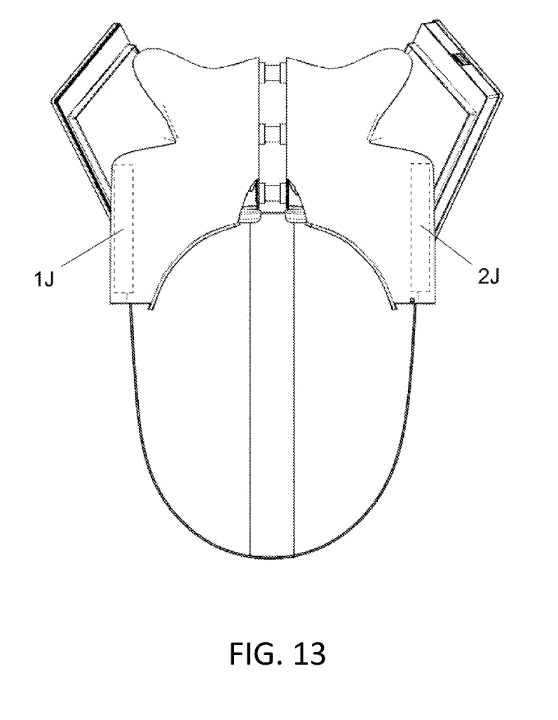

FIG. 13 shows a bottom orthogonal view of the apparatus, indicating the proposed second alternative positions of said hardware as 1J and 2J. In this drawing, 1J represents a modular assembly for the right-eye side of the invention, including a rechargeable battery pack, and a circuit board with CPU, graphics processor, memory, networking components and any other electronics that might be necessary for driving the associated display screen. 2J represents an identical assembly for the left-eye side.

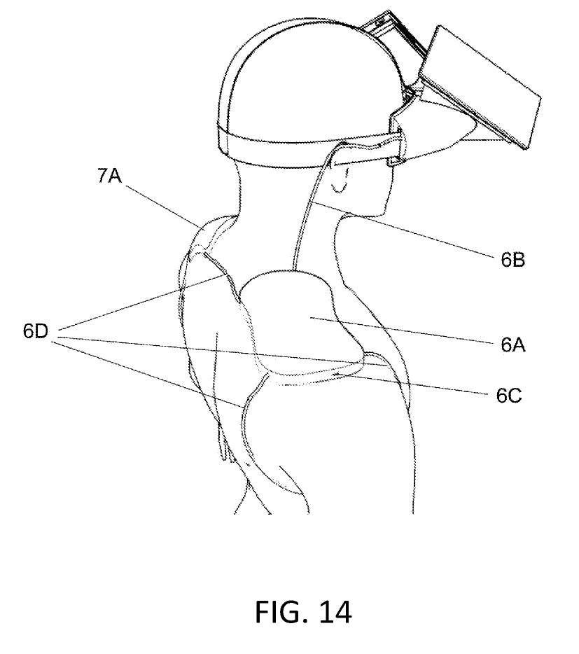

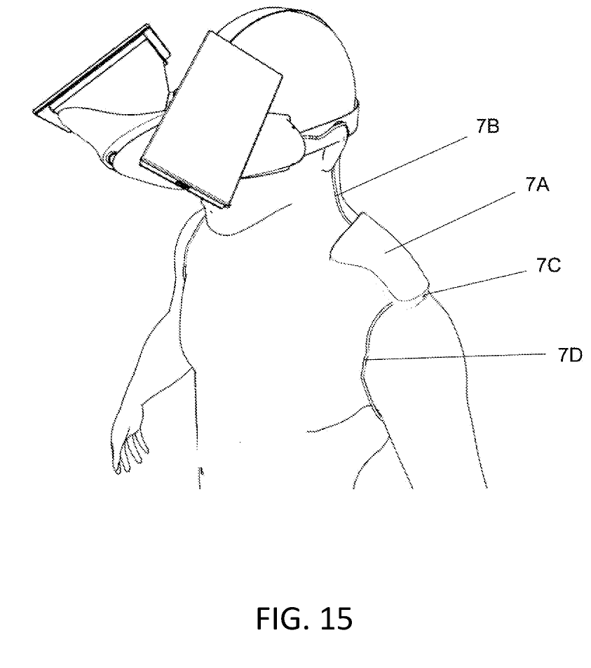

FIG. 14 and FIG. 15 show perspective views of a user wearing a shoulder-array assembly which is the third alternative location for processing, networking and battery hardware. In this configuration, modules 6A and 7A each contain a CPU, memory, graphics processing hardware, networking hardware, electronic plugs and rechargeable battery, and are located one on each of the user's shoulders. Electronic plugs 6C and 7C allow the user to connect not only a DC power cable, which itself would come from a AC/DC converter connected to an AC power outlet, for the purpose of charging the batteries of the shoulder-array, and/or to provide alternative power to the headset, but also video cables from external consumer electronic devices, such as computers, game consoles, televisions, etc.

Flexible nylon straps 6D and 7D interconnect each module and secure the shoulder-array to the user in a comfortable and convenient manner, with cabling 6B and 7B providing electronic signal transferal from the modules to the headset.

This shoulder-array configuration allows for the greatest comfort in the head, face and neck of the user, offloading much of the weight associated with conventional VR hardware.

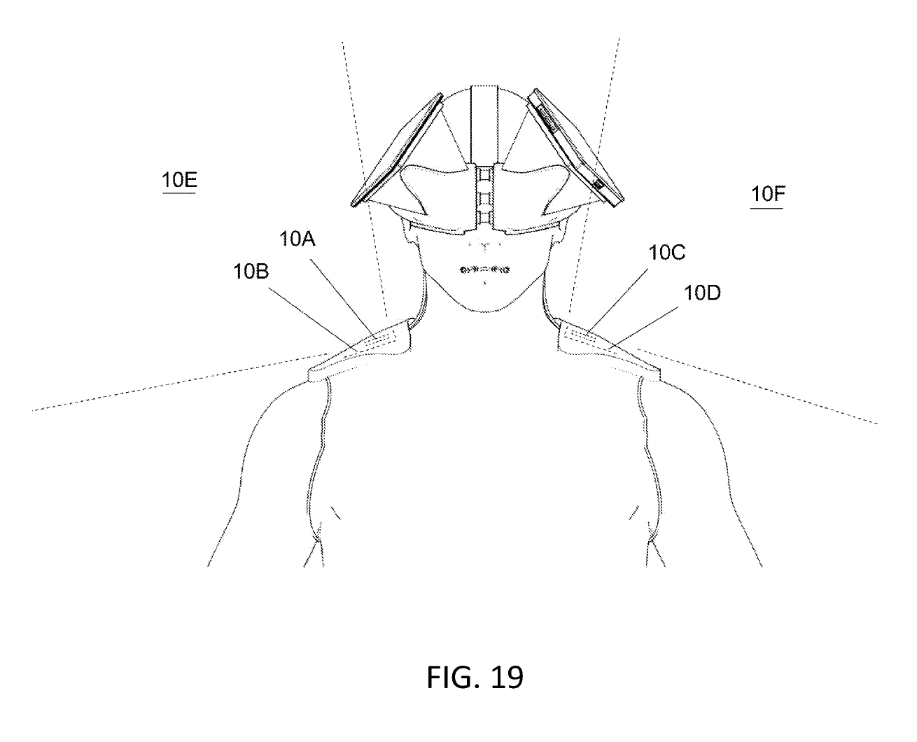

Said shoulder array could feature the alternative WIFI antenna arrangement shown in FIG. 19, in which WIFI antenna 10A sits atop lead plate 10B, which lead plate is covered with a non-toxic material such as plastic, and which lead plate is specially shaped so that it blocks the direct electromagnetic radiation from WIFI antenna 10A from being able to penetrate the user's body, thus shielding the user from said radiation. Said arrangement would allow WIFI antenna 10A to radiate upward and outward, indicated by WIFI radiation zone 10E.

This same arrangement could also be featured in the opposite shoulder-pack, to increase WIFI coverage, as indicated by WIFI antenna 10C, lead plate 10D, and WIFI radiation zone 10F.

Custom software is also needed for any version of this apparatus, due to the fact that the use of front-surface mirrors in the optics reverses or ‘flips’ the imagery on each display screen 180 degrees horizontally. For this reason, system software would require a function that would compensate for this, by ‘flipping’ all imagery 180 degrees horizontally before that imagery is placed on each display screen, so that each front-surface mirror brings the imagery back to its original orientation. This is because a mirror image of a mirror image is no longer reversed.

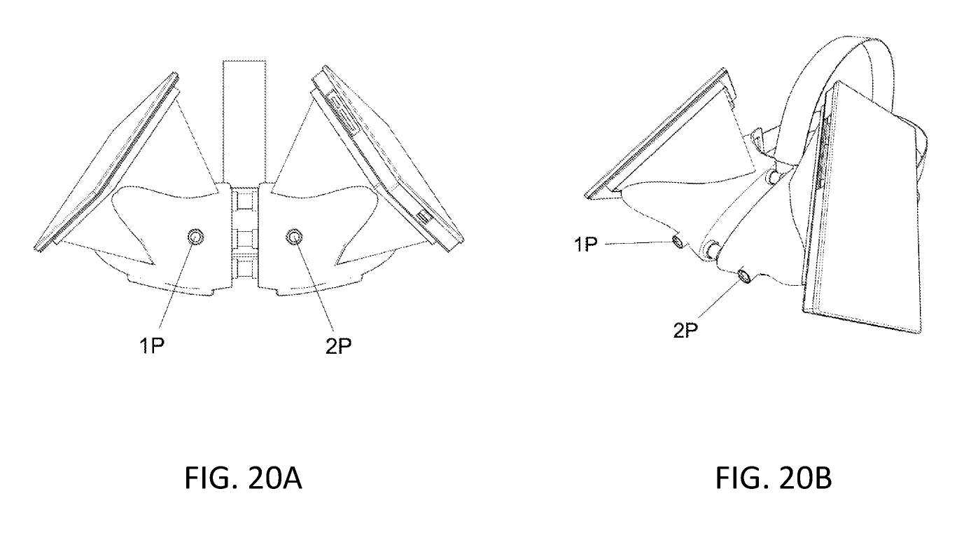

FIG. 20A shows an alternative version of the invention with two video cameras installed, video camera 1P and video camera 2P. Video camera 1P is installed in the right-eye side of the device, and video camera 2P is installed in the left-eye side of the device. Said video camera are spread apart at roughly the same distance as the average distance between the eyes of an average human, or 2.75 inches apart, although said distance can be adjusted by pushing or pulling enclosures 1 and 2 apart or together using sliding members 1G and 2G, as shown in FIG. 12A and FIG. 12A.

FIG. 20A and FIG. 20B show a pair of video cameras arranged in such a way that they can capture stereo-optic images/video of the user's real environment directly in front of the user, which images/video the device software can then integrate into the visual output of the device that is presented to the user, to facilitate Augmented Reality.

Another use of said video cameras might be to send local user environment info to remote sites or remote users, for various purposes.

The shape of enclosures 1 and 2 are only critical inasmuch as they do not obstruct the user's view of the imagery produced by the device as a whole, and that they minimize the size of the device as much as is possible and/or practical, so that the device is not overly bulky and awkward.

To accomplish these two objectives, enclosures 1B and 2B are designed in such a way that they allow the imagery from display screens 3A and 4A to pass unobstructed to front-surface mirrors 1D and 2D. Then enclosures 1A and 2A are designed in such a way that they pass said imagery from front-surface mirrors 1D and 2D to converging lenses 1C and 2C, and on to the user's eyes.

Since the cornea of the human eye is less than 0.25 inches in diameter, it means that the light rays that are travelling from display screen 3A to the user's right cornea can be seen as forming a virtual truncated pyramid, the base of which is represented as display screen 3A, which is a 16:9 rectangle, and the top of which is represented by a virtual 16:9 rectangle that is very small, that can be imagined to sit within the cornea of the user's right eye.

The exact same thing can be said of the left-eye side of the device, although in a bisymmetrical fashion.

The slope of the sides of said virtual truncated pyramid can be seen in the design of enclosures 1B and 2B, in that said enclosures slope from display screens 3A and 4A, inward to front-surface mirrors 1D and 2D. The shape of front-surface mirrors 1D and 2D are as they are since they represent a tilted cross-section of said virtual truncated pyramids.

Enclosures 1A and 2A do not exactly conform to the shape of said virtual truncated pyramids, since said enclosures have the additional functions of supporting and enclosing the optical components and other hardware, as well as providing the interface structure for the user's face, interface 1H and 2H, and supporting the strapping apparatus via slots 11 and 21.

The device featured in this documentation can be produced for different display screen sizes, in which case the sizes of front-surface mirrors 1D and 2D and converging lenses 1C and 2C would need to be adjusted to compensate, as well as the size of the enclosures. With the component sizes that are featured in this text, the size of the display screens should be 5.5 inches, diagonally measured, 16:9 ratio, which is the most common size of high-end smartphone display screens, as of the time of this writing.

The featured apparatus can also be manufactured with front-surface mirrors 1D and 2D at slightly different compound angles than those presented in this text, which would require slightly different positioning of display screens 3A and 4A, in which case said display screens would need to also be rotated to accommodate for the change of angle, so that the user sees properly positioned images, both with landscape orientation, with no horizontal deviation, which horizontal deviation would collapse and destroy the optical illusion intended for the proper usage of the device.

Although the main use of the described apparatus would be as a device for viewing 3D content, 2D content can be viewed on said device with no problem at all, a feature that would be accomplished via device software, in which case the software would feature a 2D function which would send the exact same image/video content to both display screens, instead of sending separate parallax imagery to each display screen, as is the case with 3D viewing.

All versions of said apparatus would include some type of wireless remote control to facilitate user interaction with the device hardware and software. A good choice of remote control would combine the features of an air-mouse, which functions as the pointing device, a standard gaming keypad with ‘left’/‘right’/‘up’/‘down’ keys, and an ‘enter’ key in the middle, and on the back of the remote a mini ‘qwerty’ keypad for text and numerical input, the entire remote making use of Bluetooth for wireless connection with the headset hardware and software. Since Bluetooth is ubiquitous with modern smartphones, any Bluetooth remote would offer some minimal functionality, and more exotic remotes for VR interaction would also fit well with the functionality offered by the viewer outlined in this text.

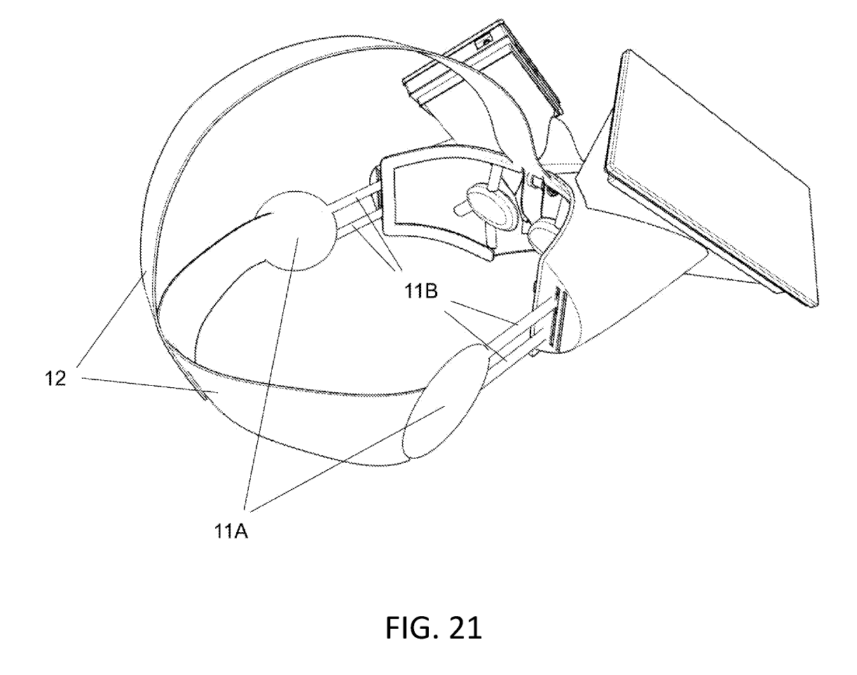

FIG. 21 shows the final alternative option for the headset, which are integrated audio headphones 11A, which themselves are held in place by spring-loaded headphone supports 11B, which keep the headphones snug against the ears of the user, and further supported by alternative head-straps 12, which head-straps also help to keep the headset secured to the head and face of the user. Audio cables in this case would be internal to headphone supports 11B, bringing the audio signal from the headset electronics to the headphone diaphragms via standard copper wire.

In the headset versions without integrated headphones, the user would be able to use their own supplied headphones or ear-buds, simply by plugging them into the audio output jack of the headset or shoulder-pack electronics, depending upon which headset alternative the user has opted for.

In the headset version with two fixed display screens, the headset should include a built-in electret condenser microphone located at the bottom of the headset, near the mouth of the user, to capture the sound of the user's voice for various use cases; telephone calls, voice-activated software features, interacting with remote users, personal notes, speech-to-text auto-dictation, etc.

1. A head-mounted apparatus, for viewing by a user of digital 3 Dimensional and 2 Dimensional content, said apparatus comprising:
two converging lenses, one for each eye of said user;
and two front-surface mirrors, one for each eye of said user;
and two display screens, with 16:9 landscape-oriented ratio, one for each eye of said user;
and CPU, memory, graphics processing hardware, networking hardware, electronic plugs and rechargeable battery to drive said display screens;
and an adjustable strap-based system for securing the device onto the head and face of said user;
and an arrangement of said components which allows said display screens to project their images onto said front-surface mirrors, said front-surface mirrors angled to reflect said images into said converging lenses, the entire apparatus aligned in such a way that each eye of said user, peering directly into said converging lenses, perceives each image with a 16:9, landscape orientation.

2. The invention in claim 1 further comprising:
two enclosures, one for each eye of said user, each said enclosure including an optical system composed of one said converging lens and one said front-surface mirror;
said optical systems being bisymmetrically configured, which bisymmetrical configuration allows said display screens to be physically spread apart from each other, at a distance which enables said 16:9 display screens to be used as a stereo-optic pair.

3. The invention in claim 2 further comprising:
said converging lenses, one for each of said user's eyes, which are manufactured with a positive diopter value which corresponds with the distance between each said converging lens and its associated front-surface mirror, plus the distance between said front-surface mirror and its associated display screen, for the purpose of allowing the eyes of said user to focus comfortably on said display screens.

4. The invention in claim 3 further comprising:
said front-surface mirrors, one for each of the user's eyes, which front-surface mirrors reflect said images from said display screens and re-direct said images toward the user's eyes, each front-surface mirror manufactured with a particular shape that, because of the fixed compound angle of each said front-surface mirror in respect to the associated eye of the user, said front-surface mirrors are perceived by the user as 16:9, landscape-oriented rectangles, which rectangles represent the reflected images emanating from said display screens.

5. The invention in claim 4 further comprising:
Said display screens, arranged and aligned in such a way that, if the user is gazing straight forward, said gaze will strike the center of each said display screen;
said arrangement and alignment also compensates for the rotational displacement caused by said front-surface mirrors, allowing the user to see both said display screens in landscape-orientation, which combination the user perceives as a singular virtual image, whether 3D or 2D, depending on the digital content.

6. The invention in claim 5 further comprising:
a system which allows the user to adjust the physical spacing between the two optical systems of said device, accommodating for the different spacing between the eyes of different users, so that the forward gaze of each user will always strike, as close as possible, the center of said display screens, which spacing adjustment allows each different user to maintain a controllable ‘global virtual depth’ of the perceived virtual image.

7. The invention in claim 6 further comprising:
a software function to reverse the images on each display screen by flipping each image 180 degrees horizontally, to compensate for the horizontal image reversal caused by the two front-surface mirrors within the device;
and a software function to reverse the horizontal polarity of the three-axis accelerometers within the hardware of the device, to compensate for the horizontal image reversal caused by the two front-surface mirrors within said device.

8. The invention in claim 7 further comprising:
a WIFI antenna featuring a lead and/or electromagnetically grounded plate behind and partially below said WIFI antenna, which lead and/or electromagnetically grounded plate shields the user's head and body from the electromagnetic waves that are emitted by said WIFI antenna.

9. The invention in claim 7 alternatively comprising:
a WIFI antenna with a mount and housing that positions said WIFI antenna above the user's head, and which features a fully enclosed lead and/or electromagnetically grounded plate, which lead and/or electromagnetically grounded plate shields the user's head and body from the electromagnetic waves that are emitted by said WIFI antenna.

10. The invention in claim 7 alternatively comprising:
two fixed 16:9, landscape-oriented display screens, along with CPU, memory, graphics processing hardware, networking hardware, electronic plugs and rechargeable battery required to drive said display screens.

11. The invention in claim 7 alternatively comprising:
a smartphone mount which allows the user to temporarily install his/her own smartphone into the apparatus, to be used for one of the two sides of the device;
and one fixed display screen, 16:9 landscape oriented, along with along with CPU, memory, graphics processing hardware, networking hardware, electronic plugs and rechargeable battery required to drive said fixed display screen.

12. The invention in claim 7 alternatively comprising:
two smartphone mounts which allow the user to temporarily install his/her own smartphones into the apparatus, to be used for both of the two sides of the device.

13. The invention in claim 7 alternatively comprising:
a shoulder-array which contains CPU, memory, graphics processing hardware, networking hardware, electronic plugs and rechargeable battery required to drive said display screens within the head-mounted apparatus;
and a WIFI antenna in one or both said shoulder-packs, each of which features a lead and/or electromagnetically grounded plate beneath and behind said WIFI antenna, which lead and/or electromagnetically grounded plate shields the user's head and body from the electromagnetic waves that are emitted from said WIFI antenna.

14. The invention in claim 7 alternatively comprising:
a pair of video cameras arranged in such a way that they capture stereo-optic images/video of the user's real environment directly in front of the user, which images/video the device software can then integrate into the visual output of the device that is presented to the user, to facilitate Augmented Reality.

15. The invention in claim 7 alternatively comprising:
Integrated audio headphones, attached to spring-loaded headphone supports which keep the headphones snug to the user's ears, and which audio cables are hidden inside said headphone supports.
